(19) United States
(12) Patent Application Publication
(10) Pub. No.: US 2022/0381358 A1
(43) Pub. Date: Dec. 1, 2022

(54) COMPOSITE VALVE APPARATUS

(71) Applicant: YAMADA MANUFACTURING CO., LTD., Kiryu-shi (JP)

(72) Inventor: Jun Fuyuki, Kiryu-shi (JP)

(21) Appl. No.: 17/728,523

(22) Filed: Apr. 25, 2022

(30) Foreign Application Priority Data
May 27, 2021 (JP) 2021-88943

(51) Int. Cl. F16K 17/00; F16K 17/04

(52) U.S. Cl. CPC F16K 17/003; F16K 17/0473

(57) ABSTRACT

A composite valve apparatus is attachable to an attachment hole. A relief-valve mechanism includes a first valve movable in the depthwise direction of an attachment hole. A thermo-valve mechanism includes a second valve fastened to a thermo actuator, and a cylindrical body that retains therein the second valve. The first valve of the relief-valve mechanism and the second valve of the thermo-valve mechanism have respective axial lines overlapping with each other. The thermo actuator is supported by the first valve, and the cylindrical body is fastened to or integrated with the first valve.

### FIELD OF THE INVENTION

The present disclosure relates to a composite valve apparatus that includes a relief-valve mechanism and a thermo-valve mechanism.

### BACKGROUND

A valve mechanism for controlling an oil is provided in an oil passage in a hydraulic circuit through which the oil flows. Japan Patent No. 6706028 B discloses a conventional technology for a valve mechanism.

Japan Patent No. 6706028 B discloses a hydraulic circuit that includes an oil pump which supplies an oil for lubricating and cooling an engine. The hydraulic circuit is provided with two return passages that return some of the oil discharged from the oil pump to an oil pan. A relief-valve mechanism that opens when the pressure of the oil flowing through the return passage reaches a predetermined pressure is provided in the one return passage. A thermo-valve mechanism that closes a valve when the temperature of the oil discharged from the oil pump reaches a predetermined temperature is provided in the other return passage.

Japan Patent No. 6767246 B discloses a specific structure of such a thermo-valve mechanism. The oil pump includes a pump housing that retains therein an inner gear and an outer gear. The pump housing is provided with a discharge passage through which the discharged oil flows, and an attachment hole to attach the thermo-valve mechanism. The attachment hole has the interior in communication with the discharge passage, and has one end directed outwardly.

The thermo-valve mechanism includes a thermo actuator that extends its entire length in the depthwise direction of the attachment hole as the temperature of the oil increases, a valve fastened to the lower end of the thermo actuator, a spring that applies force to the thermo actuator so as to compress the entire length of the thermo actuator, a cylindrical cylinder body that retains therein the thermo actuator, the spring, and the valve, and a plug member which supports the thermo actuator and the cylinder body, and which closes the open end of the attachment hole. The cylinder body is provided with an introducing hole that introduces the oil flowing through the discharge passage into the interior of the cylinder body, a drain hole which is opened or closed by the valve and which drains the oil introduced from the introducing hole to the exterior of the cylinder body, and a bottom portion that closes the lower end of the cylinder body.

By fitting the thermo-valve mechanism employing such a structure into the attachment hole, and by screwing the plug member into the open end of the attachment hole, the thermo-valve mechanism can be attached to the attachment hole.

When a relief-valve mechanism is further attached to the pump body of the oil pump in addition to the thermo-valve mechanism, in order to attach the relief-valve mechanism, the other attachment hole is formed. By fitting the relief-valve mechanism into such an attachment hole, and by screwing the plug member in the open end of the attachment hole, the relief-valve mechanism can be attached to the attachment hole. However, the oil pump that includes the relief-valve mechanism and the thermo-valve mechanism inevitably has the increased manufacturing costs.

An objective of the present disclosure is to provide a composite valve apparatus which includes a relief-valve mechanism and a thermo-valve mechanism, and which reduces the manufacturing costs.

### SUMMARY OF THE INVENTION

A composite valve apparatus according to the present disclosure is in communication with an oil passage where an oil flows through an interior, and is attachable to an attachment hole that has one end directed outwardly. This composite valve apparatus includes:

a relief-valve mechanism that releases the oil when a pressure of the oil flowing through the oil passage reaches a predetermined pressure; and

a thermo-valve mechanism that is opened or is closed when a temperature of the oil flowing through the oil passage reaches a predetermined temperature,

wherein the relief-valve mechanism includes:
a first valve that is movable in a direction becoming apart from a bottom surface of the attachment hole along a depthwise direction of the attachment hole by force applied to a pressure receiving surface that receives the pressure of the oil flowing through the oil passage;
a first spring that applies force to the first valve in a direction in which the first valve becomes close to the bottom surface of the attachment hole; and
a plug member which directly or indirectly supports the first spring and which closes the one end of the attachment hole,

wherein the thermo-valve mechanism includes:
a thermo actuator that extends an entire length in the depthwise direction of the attachment hole as the temperature of the oil increases;
a second valve fastened to the thermo actuator; and
a cylindrical body that retains therein the thermo actuator and the second valve,

wherein the cylindrical body includes:
an introducing hole capable of introducing the oil in an interior of the cylindrical body; and
a drain hole which is opened or closed by a movement of the second valve and which is capable of draining the oil introduced from the introducing hole to an exterior of the cylindrical body,

wherein the first valve of the relief-valve mechanism and the second valve of the thermo-valve mechanism have respective axial lines overlapping with each other, and

wherein the thermo actuator abuts the first valve, and the cylindrical body is fastened to or integrated with the first valve.

More specifically, according to the present disclosure, the composite valve apparatus is in communication with an oil passage where an oil flows through an interior, and is attachable to an attachment hole that has one end directed outwardly.

The composite valve apparatus includes a relief-valve mechanism that is opened and releases the oil when a pressure of the oil flowing through the oil passage reaches a predetermined pressure. The relief-valve mechanism includes a first valve that is movable in a direction becoming apart from a bottom surface of the attachment hole along a depthwise direction of the attachment hole by force applied to a pressure receiving surface that receives the pressure of the oil flowing through the oil passage, a first spring that applies force to the first valve in a direction in which the first valve becomes close to the bottom surface of the attachment hole, and a plug member which directly or indirectly supports the first spring and which closes the open end of the attachment hole.

The composite valve apparatus also includes a thermo-valve mechanism that is opened or is closed when a temperature of the oil flowing through the oil passage reaches a predetermined temperature. The thermo-valve mechanism includes a thermo actuator that extends an entire length in the depthwise direction of the attachment hole as the temperature of the oil increases, a second valve fastened to the thermo actuator, and a cylindrical body that retains therein the thermo actuator and the second valve. The cylindrical body includes an introducing hole capable of introducing the oil in an interior of the cylindrical body, and a drain hole which is opened or closed by the second valve and which is capable of draining the oil introduced from the introducing hole.

The first valve of the relief-valve mechanism and the second valve of the thermo-valve mechanism have respective axial lines overlapping with each other.

The thermo actuator abuts the first valve. The cylindrical body is fastened to or integrated with the first valve.

That is, the composite valve apparatus has the thermo actuator and cylindrical body of the thermo-valve mechanism attached to the first valve of the relief-valve mechanism. In other words, the entire thermo valve mechanism is movable together with the first valve along the axial line. Although it is a singular unit, the composite valve apparatus has two functions.

Since the composite valve apparatus is a singular unit, the number of the attachment holes to attach the composite valve apparatus is sufficient by one. Hence, the number of the attachment holes to be formed in the pump housing can be reduced. The number of the plug members that close the attachment hole is also sufficient by one. Accordingly, the manufacturing costs can be suppressed. Moreover, the space occupied by the attachment hole in the pump housing can be reduced, increasing the degree of freedom for designing a layout to place components in the pump housing.

Preferably, the cylindrical body of the thermo-valve mechanism and the thermo actuator thereof are located at an opposite side to the pressure receiving surface of the first valve of the relief-valve mechanism in a direction of the axial line. In other words, the cylindrical body and the actuator are located between the first valve and the plug member. In comparison with a case in which the cylindrical body and the actuator are provided at the pressure-receiving-surface side of the first valve, the degree of freedom for designing the pressure receiving surface of the first valve can be improved.

Preferably, an outer circumferential surface of the cylindrical body is slidable relative to an inner circumferential surface of the attachment hole. That is, the cylindrical body can be regarded as a part of the first valve. The cylindrical body forms the thermo-valve mechanism and also forms the relief-valve mechanism. Since the cylindrical body is the structural component of both mechanisms, the number of components can be reduced. Note that the cylindrical body is a member that retains therein the thermo actuator. Accordingly, it can be regarded that the thermo actuator is retained in the first valve of the relief-valve mechanism. Hence, regarding the dimension of the attachment hole in the depthwise direction, the composite valve apparatus can be downsized.

Preferably, the first spring of the relief-valve mechanism is a compression coil spring, and the second valve of the thermo-valve mechanism is located inwardly relative to the first spring in a radial direction. That is, regarding the depthwise direction of the attachment hole, the first spring and the second valve overlap with each other. Regarding the dimension of the attachment hole in the depthwise direction, the composite valve apparatus can be downsized.

### BRIEF DESCRIPTION OF THE DRAWINGS

FIG. 1 is a diagram for describing a composite valve apparatus according to a first embodiment and an attachment hole for the composite valve apparatus;

FIG. 2 is an exploded perspective view of the composite valve apparatus illustrated in FIG. 1;

FIG. 3 is a cross-sectional view of the composite valve apparatus illustrated in FIG. 1;

FIG. 4A is a diagram for describing a relief-valve mechanism in a closed state, and FIG. 4B is a diagram for describing the relief-valve mechanism in an open state;

FIG. 5A is a diagram for describing a thermo-valve mechanism in an open state, and FIG. 5B is a diagram for describing the thermo-valve mechanism in a closed state;

FIG. 6A is a diagram for describing the composite valve apparatus with the relief-valve mechanism being in a closed state and with the thermo-valve mechanism being in an open state, and, FIG. 6B is a diagram for describing the composite valve apparatus with the relief-valve mechanism being in an open state, and with the thermo-valve mechanism being in an open state;

FIG. 7A is a diagram for describing the composite valve apparatus with the relief-valve mechanism being in a closed state, and with the thermo-valve mechanism being in a closed state, and, FIG. 7B is a diagram for describing the composite valve apparatus with the relief-valve mechanism being in an open state and with the thermo-valve mechanism being in a closed state; and

FIG. 8A is a diagram for describing a relief-valve mechanism in a closed state according to a second embodiment, and FIG. 8B is a diagram for describing the relief-valve mechanism in an open state according to the second embodiment.

### DETAILED DESCRIPTION OF THE EMBODIMENTS

Embodiments of the present disclosure will be described below with reference to the accompanying figures. Note that “Up” and “Dn” in the figures indicate an upper side and a down side, respectively.

### First Embodiment

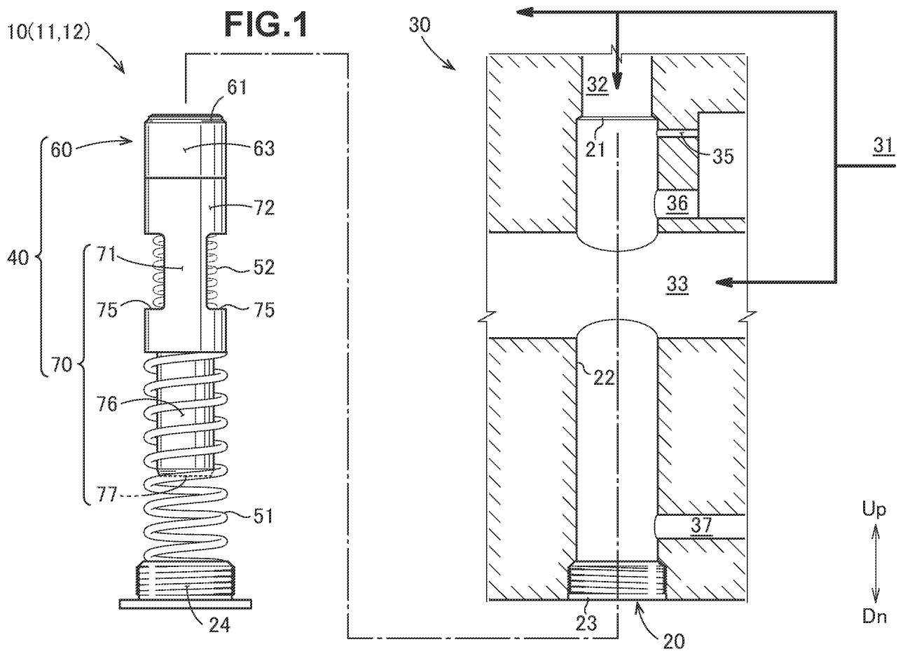

FIG. 1 illustrates a composite valve apparatus 10 according to a first embodiment, and a pump housing 30 of an unillustrated oil pump provided with an attachment hole 20 to which the composite valve apparatus 10 can be attached. Note that instead of the pump housing 30, as far as an oil passage through which an oil flows is formed in the interior, and such an ail passage and the interior of the attachment hole 20 is in communication with each other, a structures like a cylinder block may be adopted. That is, it is not limited to the oil pump, and the composite valve apparatus 10 may be provided in a hydraulic circuit as appropriate.

(Attachment Hole)

An open end 23 of the attachment hole 20 is directed outwardly (downwardly). The diameter of the attachment hole 20 is constant from the open end 23 to a bottom surface 21. In the following description, in order to facilitate understanding, a direction along the depthwise direction of the attachment hole 20 will be defined as a vertical direction, a direction becoming close to the bottom surface 21 will be defined as an upper side, and a direction becoming close to the open end 23 will be defined as a down side. Note that the vertical direction may be not consistent with the perpendicular direction.

(Discharge Passage)

An oil passage through which an oil discharged from the oil pump flows will be defined as a discharge passage 31. Moreover, oil passages branched from the discharge passage 31 will be defined as a first discharge passage 32 and a second discharge passage 33.

The first discharge passage 32 is in communication with the interior of the attachment hole 20 through a hole of the bottom surface 21 of the attachment hole 20. The pump housing 30 is provided with a first drain passage 35 and a second drain passage 36 which drain the oil flowing from the first discharge passage 32 from the interior of the attachment hole 20. The two drain passages 35 and 36 are located above the second discharge passage 33. The two drain passages are in communication with an inner circumferential surface 22 of the attachment hole 20.

The second discharge passage 33 is in communication with the interior of the attachment hole 20 through a hole of the inner circumferential surface 22 of the attachment hole 20. More specifically, the second discharge passage 33 is orthogonal to the depthwise direction of the attachment hole 20, and passes completely through the inner circumferential surface 22 of the attachment hole 20 in the radial direction.

A third drain passage 37 that drains the oil flowing from the second discharge passage 33 from the interior of the attachment hole 20 is formed in the pump housing 30. The third drain passage 37 is located below the second discharge passage 33.

(Functions of Composite Valve Apparatus)

The composite valve apparatus 10 includes a relief-valve mechanism 11 that is actuated by the pressure of the oil flowing through the first discharge passage 32, and a thermo-valve mechanism 12 that is actuated by the heat of the oil flowing through the second discharge passage 33.

(Relief-Valve Mechanism)

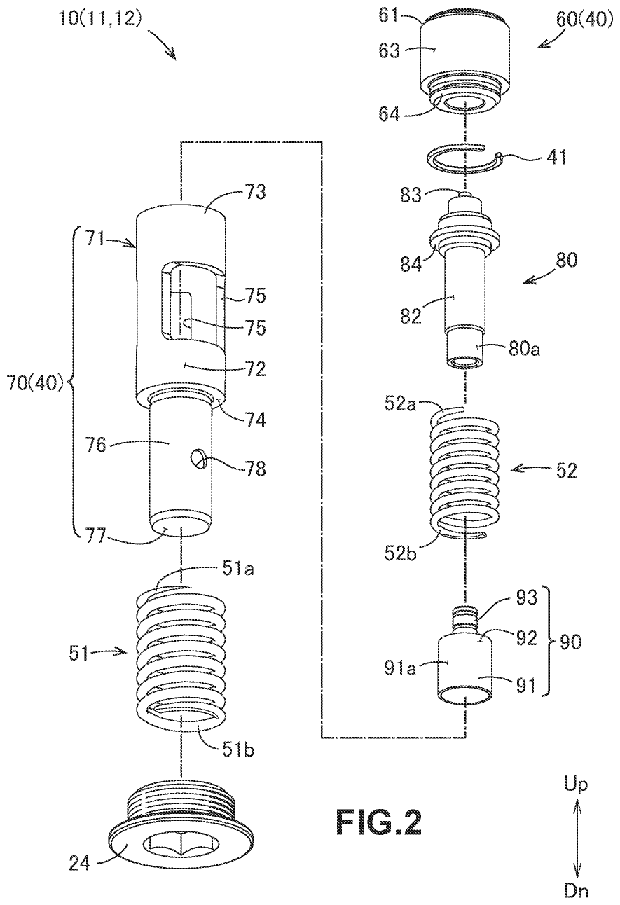

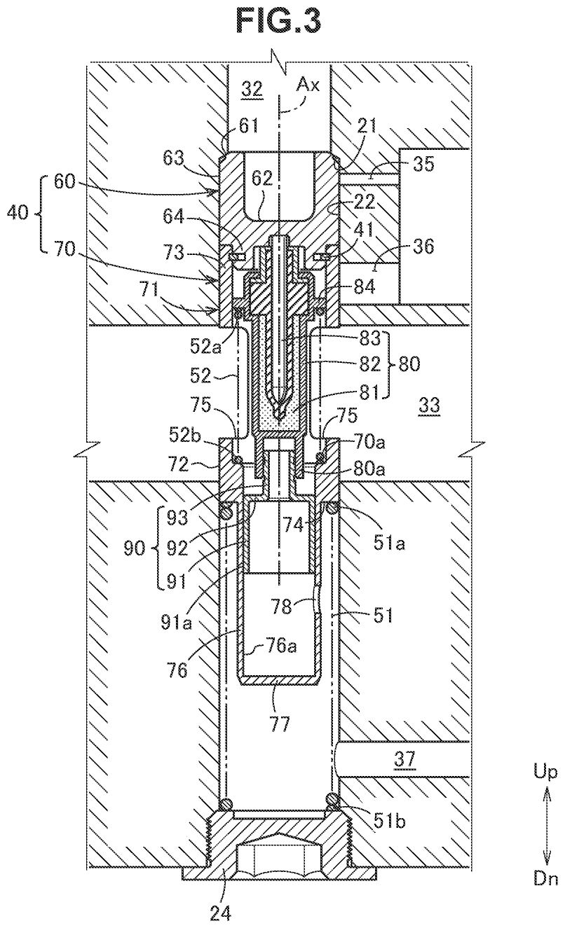

With reference to FIG. 2 and FIG. 3, the relief-valve mechanism 11 includes a first valve 40 that can reciprocate in the depthwise direction (the vertical direction) of the attachment hole 20, a first spring 51 that applies force to the first valve 40 in the direction in which the first valve 40 becomes close to the bottom surface 21 of the attachment hole 20, and a plug member 24 which supports the first spring 51 directly or indirectly via any member, and which closes the open end 23 (see FIG. 1) of the attachment hole 20.

(First Valve)

The first valve 40 includes a valve upper component 60 and a valve lower component 70 (a cylindrical body) which are fastened with each other. Note that although it is not illustrated in the figure, the valve upper component 60 and the valve lower component 70 may be an integrated singular component.

An outer circumferential surface 63 of the valve upper component 60 is slidable relative to the inner circumferential surface 22 of the attachment hole 20. The valve upper component 60 is formed in a substantially cylindrical shape. More specifically, the valve upper component 60 includes an annular edge 61 that can be in contact with the bottom surface 21 of the attachment hole 20, a pressure receiving surface 62 which is concaved from the annular edge 61 and which receives the pressure of the oil flowing through the first discharge passage 32, and an annular fastening portion 64 which is provided at the opposite side to the pressure receiving surface 62 in the direction along an axial line Ax, and to which the valve lower component 70 can be fastened, and those are integrated with each other. The outer circumferential surface 63 and the fastening portion 64 may be separate components from each other.

The valve lower component 70 has a cylindrical large-diameter portion 71. An outer circumferential surface 72 of the large-diameter portion 71 is slidable relative to the inner circumferential surface 22 of the attachment hole 20. The inner circumferential surface of an upper end portion 73 (one end of the cylindrical body) of the large-diameter portion 71 and the outer circumferential surface of the fastening portion 64 are engaged with each other through a C-shape retainer ring 41. That is, the valve lower component 70 is provided at the opposite side to the pressure receiving surface 62 in the direction along the axial line Ax. In other words, the valve lower component 70 is located between the valve upper component 60 of the first valve 40 and the plug member 24. Note that although it is not illustrated in the figure, the thermo-valve mechanism 12 may be provided at the pressure-receiving-surface-62 side of the valve upper component 60.

(First Spring)

The first spring 51 is a compression coil spring. An upper end portion 51a of the first spring 51 is supported by or abuts an annular lower end surface 74 of the large-diameter portion 71.

(Plug Member)

The plug member 24 is screwed in and fastened to the open end 23 of the attachment hole 20. The plug member 24 supports or abuts a lower end portion 51b of the first spring 51.

(Opening and Closing Actions of Relief-Valve Mechanism)

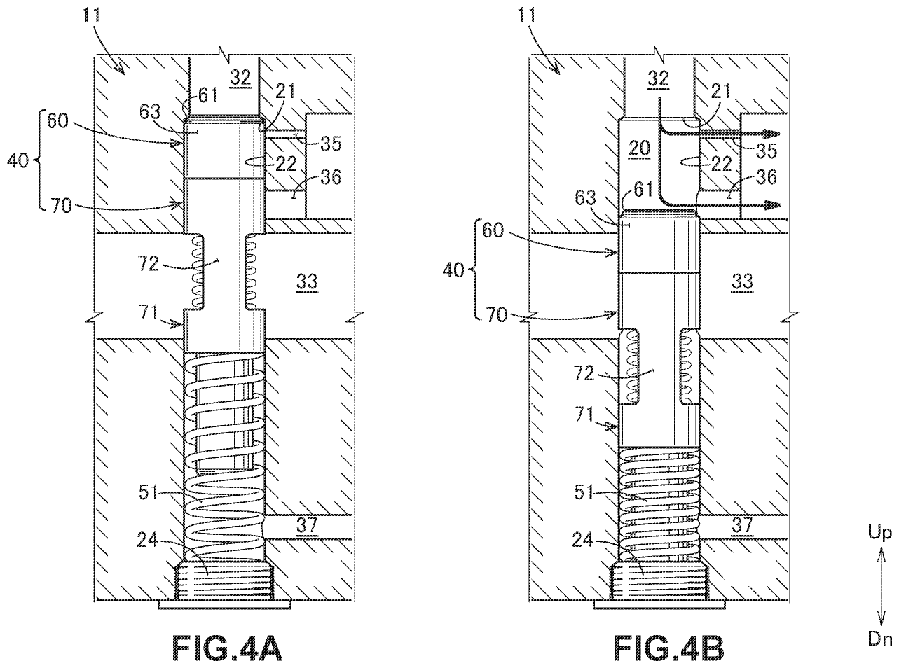

FIG. 4A illustrates the relief-valve mechanism 11 in a closed state. In a state in which the pressure of the oil flowing through the first discharge passage 32 does not reach the predetermined pressure, the annular edge 61 of the first valve 40 is in contact with the bottom surface 21 of the attachment hole 20. The outer circumferential surface 63 of the valve upper component 60 blocks off the first drain passage 35. The outer circumferential surface 72 of the large-diameter portion 71 of the valve lower component 70 blocks off the second drain passage 36. The large-diameter portion 71 is located so as to traverse the second discharge passage 33. Note that FIG. 4A can be regarded as a state immediately after the composite valve apparatus 10 is attached to the attachment hole 20.

When the pressure of the oil flowing through the first discharge passage 32 increases, the first valve 40 moves downwardly against the pushing force from the first spring 51.

FIG. 4B illustrates the relief-valve mechanism in an open state. In a state in which the pressure of the oil flowing through the first discharge passage 32 reaches the predetermined pressure, the first discharge passage 32, the first drain passage 35 and the second drain passage 36 are in communication with each other through the attachment hole 20. The oil in the first discharge passage 32 flows in the first drain passage 35 and the second drain passage 36, is returned to an unillustrated oil pan that reserves the oil and an unillustrated suction passage, and thus the pressure of the oil flowing through the first discharge passage 32 can be decreased.

When the pressure of the oil flowing through the first discharge passage 32 decreases, the first valve 40 moves upwardly by the pushing force of the first spring 51, the first valve 40 blocks off the first drain passage 35 and the second drain passage 36, and thus the relief-valve mechanism becomes a closed state illustrated in FIG. 4A.

Note that the number of openings that allows the oil flowing from the first discharge passage 32 to bypass can be changed as appropriate. A state in which at least the first drain passage 35 is opened can be regarded as the open state of the relief-valve mechanism 11.

(Thermo-Valve Mechanism)

With reference to FIG. 2 and FIG. 3, the thermo-valve mechanism 12 includes a valve lower component 70, a thermo actuator 80 retained in a large-diameter portion 71 of the valve lower component 70, a second valve 90 fastened to a lower end portion 80a (one end of the thermo actuator 80) of the thermo actuator 80, and a second spring 52 that applies force to the thermo actuator 80 in the direction in which the thermo actuator 80 becomes close to the valve upper component 60.

(Valve Lower Component)

The valve lower component 70 includes a cylindrical small-diameter portion 76 that extends from the lower inner circumferential edge of the cylindrical large-diameter portion 71 toward the plug member 24, and a bottom portion 77 that closes the lower side of the small-diameter portion 76. The large-diameter portion 71, the small-diameter portion 76, and the bottom portion 77 are integrated with each other as a singular component. The interior of the large-diameter portion 71 and that of the small-diameter portion 76 are in communication with each other.

The large-diameter portion 71 is provided with a pair of introducing holes 75 and 75 that are opened so as to introduce the oil in the interior of the large-diameter portion 71. The respective introducing holes 75 and 75 are offset by 180 degrees relative to each other in the circumferential direction.

The small-diameter portion 76 is provided with a drain hole 78 that is opened so as to cause the oil flowing in the interior of the small-diameter portion 76 from the large-diameter portion 71 to discharge to the exterior of the valve lower component 70.

(Thermo Actuator)

The thermo actuator 80 has characteristics such that as the temperature of the oil flowing through the second discharge passage 33 increases, the entire length in the depthwise direction of the attachment hole 20 extends. More specifically, the thermo actuator 80 includes a wax 81 that expands by the heat of the oil, a casing 82 that retains therein the wax 81, and a rod 83 which has a part embedded in the wax 81, and which is pushed out and protrudes further from the casing 82 by the expansion of the wax 81.

The upper end (the other end of the thermo actuator) of the rod 83 is supported by or abuts the internal side in the radial direction of the fastening portion 64 of the first valve 40.

(Second Valve)

The second valve 90 includes a cylindrical main body portion 91 that has an outer circumferential surface 91a which is slidable relative to an inner circumferential surface 76a of the small-diameter portion 76, a lid portion 92 that blocks off the upper end of the main body portion 91, and a fastening portion 93 which extends from the lid portion 92 toward the thermo actuator 80, and which is fastened to the thermo actuator 80, and those are integrated with each other as a singular component. The fastening portion 93 of the second valve 90 is fitted in a lower end portion 80a of the thermo actuator 80, and those are swaged with each other so as to be fastened to each other.

The second valve 90 is located inside the first spring 51 in the radial direction.

The first spring 51 is placed so as to surround the small-diameter portion 76.

(Second Spring)

The second spring 52 is retained in the large-diameter portion 71 of the valve lower component 70 together with the thermo actuator 80. The second spring 52 is a compression coil spring, and is placed so as to surround the casing 82 of the thermo actuator 80.

An upper end portion 52a of the second spring 52 is supported by or abuts a spring retaining portion 84 formed integrally with the outer circumferential surface of the casing 82. A lower end portion 52b of the second spring 52 is supported by or abuts an annular stepped surface 70a that connects the inner circumferential surface of the large-diameter portion 71 and the inner circumferential surface 76a of the small-diameter portion 76 with each other.

(Opening and Closing Actions of Thermo-Valve Mechanism)

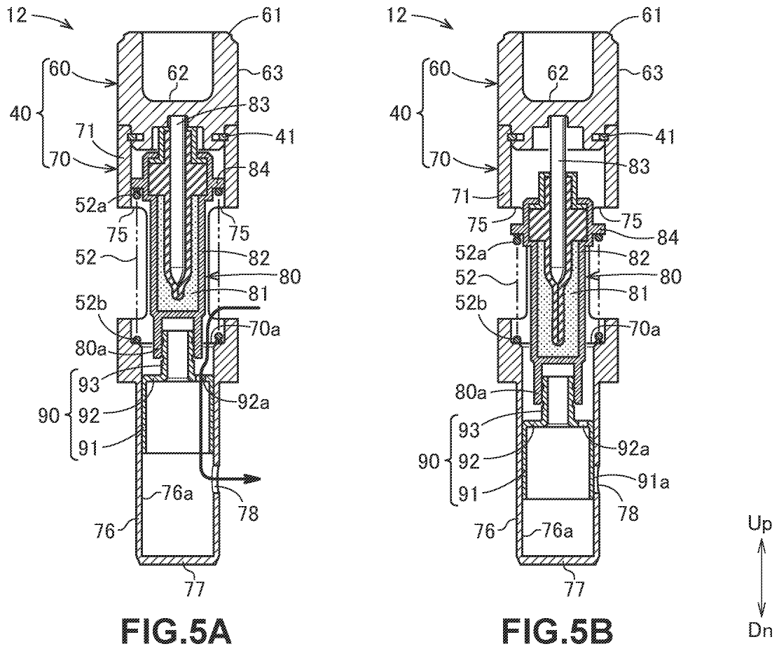

FIG. 5A illustrates the thermo-valve mechanism 12 in an open state. In a state in which the temperature of the oil flowing through the second discharge passage 33 (see FIG. 3) does not reach the predetermined temperature, the main body portion 91 of the second valve 90 is located above the drain hole 78.

The oil flowing in the interior of the large-diameter portion 71 from the introducing holes 75 and 75 of the large-diameter portion 71 passes through a hole 92a of the lid portion 92 of the second valve 90, flows in the interior of the main body portion 91 of the second valve 90, and is drained from the drain hole 78 of the small-diameter portion 76.

When the temperature of the oil increases, the heat of the oil is transferred to the wax 81 through the casing 82 of the thermo actuator 80. When the wax 81 expands, the rod 83 protrudes upwardly relative to the casing 82 of the thermo-valve mechanism 12 against the pushing force by the second spring 52. The upper end of the rod 83 is supported by or abuts the first valve 40. Accordingly, the casing 82 moves downwardly relative to the valve upper component 60 of the first valve 40. The second valve 90 fastened to the lower end portion 80a of the thermo actuator 80 moves downwardly.

FIG. 5B illustrates the thermo-valve mechanism 12 in a closed state. In a state in which the temperature of the oil flowing through the second discharge passage 33 (see FIG. 3) exceeds the predetermined temperature, the outer circumferential surface 91a of the main body portion 91 of the second valve 90 blocks off the drain hole 78. Accordingly, the oil flowing in the interior of the large-diameter portion 71 is not drained from the drain hole 78.

When the temperature of the oil flowing through the second discharge passage 33 decreases, the casing 82 of the thermo actuator 80 moves upwardly by the force of the second spring 52, the main body portion 91 of the second valve 90 is located above the drain hole 78, and thus the thermo-valve mechanism 12 becomes an open state illustrated in FIG. 5A.

Although the thermo-valve mechanism 12 of the composite valve apparatus 10 according to the first embodiment employs a structure that is closed when the temperature of the oil flowing through the second discharge passage 33 reaches the predetermined temperature, when the composite valve apparatus 10 is provided in another hydraulic circuit, a structure in which the position of the drain hole 78 is changed as appropriate so as to be opened when the temperature of the oil reaches the predetermined temperature.

(Opening and Closing Actions of Composite Valve Apparatus)

The relief-valve mechanism 11 illustrated in FIG. 4A and FIG. 4B, and the thermo-valve mechanism 12 illustrated in FIG. 5A and FIG. 5B actuate independently from each other. That is, the composite valve apparatus 10 has four states that are a combination of the open and closed states of the relief-valve mechanism 11 and the open and closed states of the thermo-valve mechanism 12.

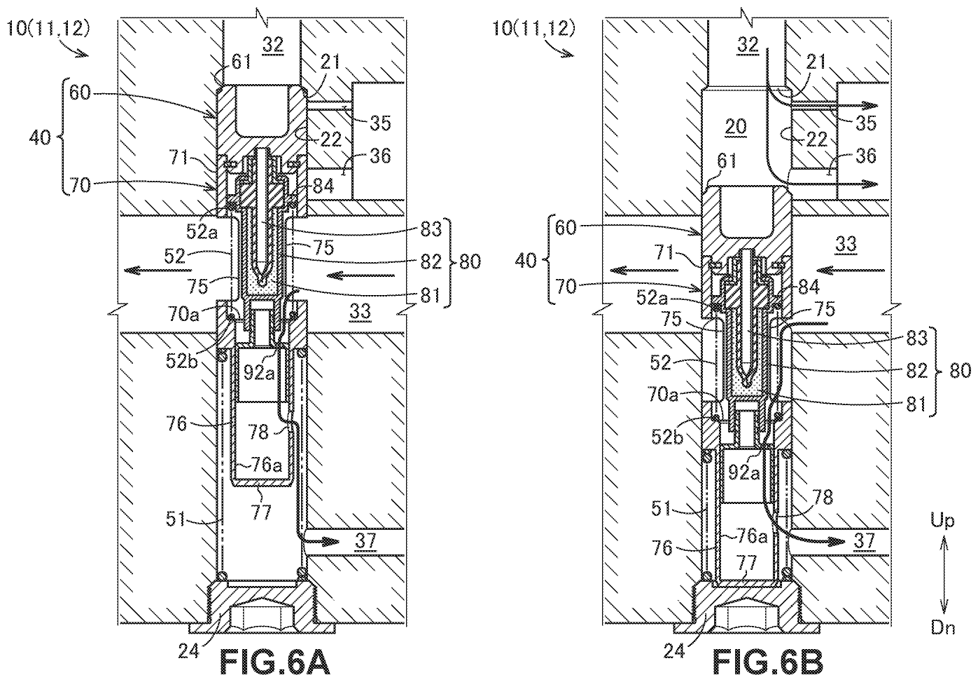

FIG. 6A illustrates the composite valve apparatus 10 in which the relief-valve mechanism 11 is in a closed state, and the thermo-valve mechanism 12 is in an open state.

The first valve 40 blocks off the first drain passage 35 and the second drain hole 36. The oil does not flow to the first drain passage 35 and the second drain hole 36 from the first discharge passage 32. The drain hole 78 of the small-diameter portion 76 is opened. The oil drained from the drain hole 78 flows in the third drain passage 37, and is returned to the oil pan that reserves the oil and the suction passage.

FIG. 6B illustrates the composite valve apparatus 10 in which the relief-valve mechanism 11 is in an open state and the thermo-valve mechanism 12 is also in an open state.

The first discharge passage 32, the first drain passage 35 and the second drain passage 36 are in communication with each other through the attachment hole 20. The oil flowing through the first discharge passage 32 flows in the first drain passage 35 and in the second drain passage 36 through the interior of the attachment hole 20. The drain hole 78 of the small-diameter portion 76 is open. The oil drained from the drain hole 78 flows in the third drain passage 37, and is returned to the oil pan that reserves the oil and the suction passage.

Note that the introducing passage and the second discharge passage 33 are always in communication with each other through the interior of the first valve 40 regardless of the position of the first valve 40.

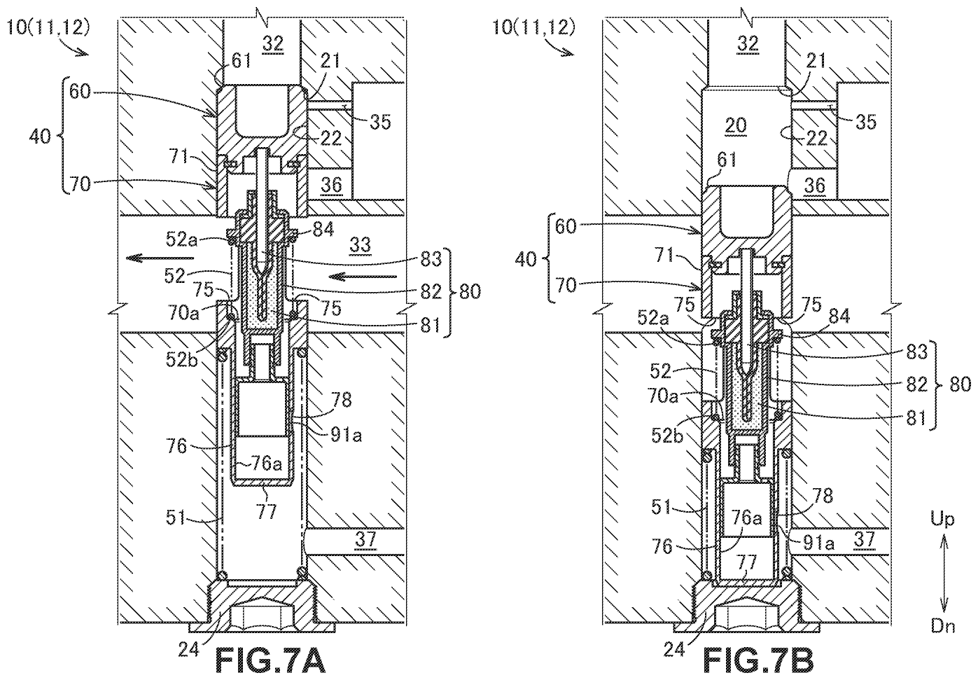

FIG. 7A illustrates the composite valve apparatus 10 in which the relief-valve mechanism 11 is in a closed state and the thermo-valve mechanism 12 is also in a closed state.

The first valve 40 blocks off the first drain passage 35 and the second drain passage 36. The second valve 90 blocks off the drain hole 78 of the small-diameter portion 76.

FIG. 7B illustrates the composite valve apparatus 10 in which the relief-valve mechanism 11 is in an open state and the thermo-valve mechanism 12 is in a closed state.

The first discharge passage 32, the first drain passage 35 and the second drain passage 36 are in communication with each other through the attachment hole 20. The oil flowing through the first discharge passage 32 flows in the first drain passage 35 and in the second drain passage 36 through the interior of the attachment hole 20. The second valve 90 blocks off the drain hole 78 of the small-diameter portion 76.

(Advantageous Effects of First Embodiment)

(Suppressing Manufacturing Costs)

With reference to FIG. 2 and FIG. 3, the composite valve apparatus 10 is attachable to the attachment hole 20 that has the open end 23 directed outwardly. The interior of the attachment hole 20 is in communication with the first discharge passage 32 and with the second discharge passage 33.

The composite valve apparatus 10 includes the relief-valve mechanism 11 that becomes an open state (see FIG. 4B) when the pressure of the oil flowing through the first discharge passage 32 reaches the predetermined pressure. The relief-valve mechanism 11 includes the first valve 40 movable in the direction becoming apart from the bottom surface 21 of the attachment hole 20 along the depthwise direction of the attachment hole 20 by the force applied to the pressure receiving surface 62 that receives the pressure of the oil flowing through the first discharge passage 32, the first spring 51 that applies the force to the first valve 40 in the direction in which the first valve 40 becomes close to the bottom surface 21 of the attachment hole 20, and the plug member 24 which supports the first spring 51 and which closes the open end 23 of the attachment hole 20.

The composite valve apparatus 10 includes the thermo-valve mechanism 12 that becomes a closed state (see FIG. 5B) when the temperature of the oil flowing through the second discharge passage 33 increases and reaches the predetermined temperature. The thermo-valve mechanism 12 includes the thermo actuator 80 that extends the entire length along the depthwise direction of the attachment hole 20 as the temperature of the oil increases, the second valve 90 fastened to the lower end of the thermo actuator 80, and the valve lower component 70 that retains therein the thermo actuator 80 and the second valve 90. The valve lower component 70 includes the introducing holes 75 and 75 that introduce the oil into the interior of the valve lower component 70, the drain hole 78 which is opened or closed by the second valve 90 and which drains the oil introduced from the introducing holes 75 and 75, and the bottom portion 77 that closes the lower end of the small-diameter portion 76.

The first valve 40 of the relief-valve mechanism 11 and the second valve 90 of the thermo-valve mechanism 12 have respective axial lines Ax overlapping with each other. The upper end of the rod 83 of the thermo actuator 80 is supported by or abuts the first valve 40. The upper end portion 73 of the valve lower component 70 is fastened to or integrated with the first valve 40.

That is, the composite valve apparatus 10 has the thermo actuator 80 and valve lower component 70 of the thermo-valve mechanism 12 attached to the valve upper component 60 of the relief-valve mechanism 11. In other words, the entire thermo-valve mechanism 12 is movable along the axial line Ax together with the valve upper component 60. Although the composite valve apparatus 10 is a singular unit, it has two functions.

Since the composite valve apparatus 10 is a singular unit, the number of the attachment holes 20 to attach the composite valve apparatus 10 is sufficient by one. Hence, the number of the attachment holes 20 to be formed in the pump housing 30 can be reduced. The number of the plug members 24 that close the attachment hole 20 is also sufficient by one. Accordingly, the manufacturing costs can be suppressed.

Moreover, the space occupied by the attachment hole 20 in the pump housing 30 can be reduced, increasing the degree of freedom for designing a layout to place components in the pump housing 30.

Note that when the valve upper component 60 and the valve lower component 70 are integrated with each other, the number of components can be reduced.

(Improvement of Degree of Freedom for Designing Pressure Receiving Surface of First Valve)

The valve lower component 70 and thermo actuator 80 of the thermo-valve mechanism 12 are located at the opposite side to the pressure receiving surface 62 of the valve upper component 60 of the relief-valve mechanism 11. Hence, in comparison with a case in which the thermo-valve mechanism 12 is provided at the pressure-receiving-surface-62 side, the degree of freedom for designing the pressure receiving surface 62 of the valve upper component 60 increases.

(Downsizing of Composite Valve Apparatus)

Since the outer circumferential surface 72 of the large-diameter portion 71 of the valve lower component 70 is slidable relative to the inner circumferential surface 22 of the attachment hole 20, the large-diameter portion 71 of the valve lower component 70 can be regarded as a part of the first valve 40. The valve lower component 70 forms the thermo-valve mechanism 12, and also forms the relief-valve mechanism 11. Since the valve lower component 70 is the structural component of both mechanisms, the number of components can be reduced.

Note that the valve lower component 70 is a member that retains therein the thermo actuator 80. Accordingly, it can be regarded that the thermo actuator 80 is retained in the first valve 40 of the relief-valve mechanism 11. Hence, regarding the dimension of the attachment hole 20 in the depthwise direction, the composite valve apparatus 10 can be downsized.

In addition, the first spring 51 of the relief-valve mechanism 11 is a compression coil spring. The second valve 90 of the thermo-valve mechanism 12 is located inwardly relative to the first spring 51 in the radial direction. That is, the first spring 51 and the second valve 90 overlap in the depthwise direction of the attachment hole 20. Regarding the dimension of the attachment hole 20 in the depthwise direction, the composite valve apparatus 10 can be downsized.

The advantageous effects of the above-described first embodiment are also accomplished in a second embodiment to be described below. The same structural component as that of the first embodiment will be denoted by the same reference numeral as that of the first embodiment, and the duplicated description thereof will be omitted.

### Second Embodiment

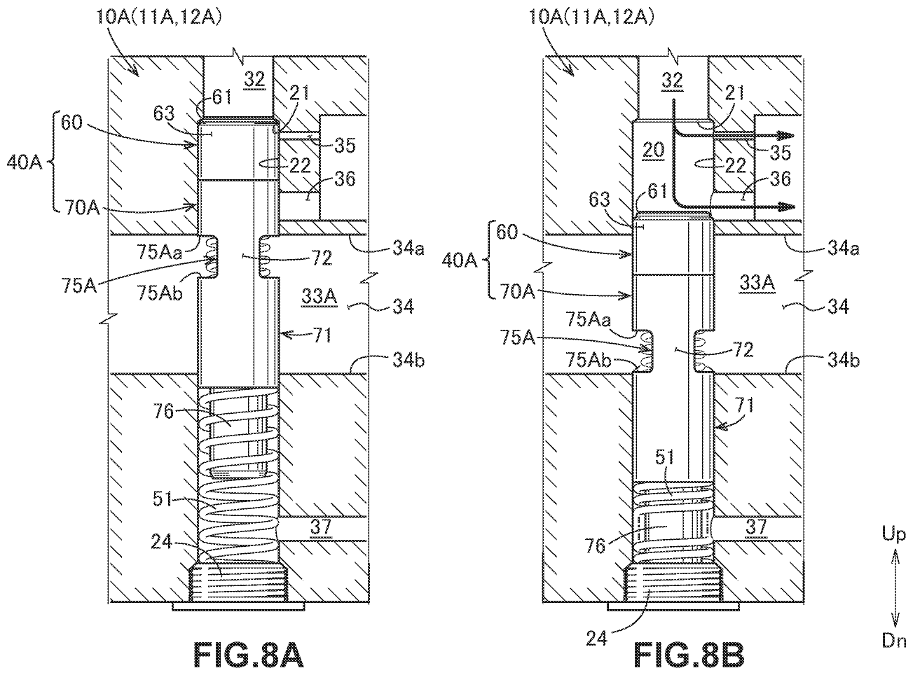

FIG. 8A illustrates a composite valve apparatus 10A in which a relief-valve mechanism 11A is in a closed state. With the annular edge 61 of the valve upper component 60 of a first valve 40A being in contact with the bottom surface 21 of the attachment hole 20, an upper end 75Aa of an introducing hole 75A of a valve lower component 70A is located below an upper end 34a of a wall surface 34 that defines a second discharge passage 33A.

FIG. 8B illustrates the composite valve apparatus 10A in which the relief-valve mechanism 11A is in an open state. When the first valve 40 is located at the lowermost position (i.e., when the small-diameter portion 76 of the valve lower component 70A is in contact with the plug member 24, or when the pressure of the oil flowing through the first discharge passage 32 increases to the maximum), a lower end 75Ab of the introducing hole 75A of the valve lower component 70A is located above a lower end 34b of the wall surface 34 that defines a second discharge passage 33A.

According to the above-described structure, the flow passage area of the introducing hole 75A of the thermo-valve mechanism 12A is constant regardless of the position of the first valve 40A of the relief-valve mechanism 11A. Hence, the actuation of the relief-valve mechanism 11A does not affect to the actuation of the thermo-valve mechanism A.

Note that as far as the actions and advantageous effects of the present disclosure can be accomplished, the present disclosure is not limited to the first and second embodiments.

1. A composite valve apparatus which is in communication with an oil passage where an oil flows through an interior and which is attachable to an attachment hole that has one end directed outwardly comprising:
a relief-valve mechanism that releases the oil when a pressure of the oil flowing through the oil passage reaches a predetermined pressure; and
a thermo-valve mechanism that is opened or is closed when a temperature of the oil flowing through the oil passage reaches a predetermined temperature,
wherein the relief-valve mechanism comprises:
a first valve that is movable in a direction becoming apart from a bottom surface of the attachment hole along a depthwise direction of the attachment hole by force applied to a pressure receiving surface that receives the pressure of the oil flowing through the oil passage;
a first spring that applies force to the first valve in a direction in which the first valve becomes close to the bottom surface of the attachment hole; and
a plug member which directly or indirectly supports the first spring and which closes the one end of the attachment hole,
wherein the thermo-valve mechanism comprises:
a thermo actuator that extends an entire length in the depthwise direction of the attachment hole as the temperature of the oil increases;
a second valve fastened to the thermo actuator; and
a cylindrical body that retains therein the thermo actuator and the second valve,
wherein the cylindrical body comprises:
an introducing hole capable of introducing the oil in an interior of the cylindrical body; and
a drain hole which is opened or closed by a movement of the second valve and which is capable of draining the oil introduced from the introducing hole to an exterior of the cylindrical body,
wherein the first valve of the relief-valve mechanism and the second valve of the thermo-valve mechanism have respective axial lines overlapping with each other, and
wherein the thermo actuator abuts the first valve, and the cylindrical body is fastened to or integrated with the first valve.

2. The composite valve apparatus according to claim 1, wherein the cylindrical body of the thermo-valve mechanism and the thermo actuator thereof are located at an opposite side to the pressure receiving surface of the first valve of the relief-valve mechanism in a direction of the axial line.

3. The composite valve apparatus according to claim 2, wherein an outer circumferential surface of the cylindrical body is slidable relative to an inner circumferential surface of the attachment hole.

4. The composite valve apparatus according to claim 2, wherein:
the first spring of the relief-valve mechanism is a compression coil spring; and
the second valve of the thermo-valve mechanism is located inwardly relative to the first spring in a radial direction.

5. The composite valve apparatus according to claim 3, wherein:
the first spring of the relief-valve mechanism is a compression coil spring; and
the second valve of the thermo-valve mechanism is located inwardly relative to the first spring in a radial direction.
